(19) United States
(12) Patent Application Publication
(10) Pub. No.: US 2006/0113401 A1
(43) Pub. Date: Jun. 1, 2006

(54) Anti-icing spray system

(75) Inventors: Patrick A. Leonhardt, Rocklin, CA (US); Sean Thompson, Sacramento, CA (US)

Correspondence Address: BRINKS HOFER GILSON & LIONE, P.O. BOX 10395, CHICAGO, IL, 60610, US

(73) Assignee: Energy Absorption Systems, Inc.

(21) Appl. No.: 10/998,864

(22) Filed: Nov. 29, 2004

(51) Int. Cl. B05B 1/14

(52) U.S. Cl. 239/69; 239/550; 239/569; 404/75

(57) ABSTRACT

A method of applying an anti-icing solution to a roadway includes providing a plurality of spaced apart spray nozzles defining a system length. The plurality of spray nozzles are coupled to a plurality of spray valves. The method further includes supplying a pressurized anti-icing solution to each of the plurality of spray valves from a source of the anti-icing solution positioned upstream of the plurality of said spray valves. The method also includes opening the plurality of spray valves for a plurality of predetermined time periods, wherein the predetermined time periods of at least some of the plurality of spray valves are greater than the predetermined time periods of at least some other of the plurality of spray valves positioned upstream therefrom. In another aspect, an anti-icing assembly includes an anti-icing solution source, a valve in fluid communication with the anti-icing solution source, a nozzle connected to the valve, and a pressure detecting device coupled between the nozzle and the valve.

### BACKGROUND

This invention relates to an improved anti-icing spray system, and in particular, to an anti-icing spray system that provides a uniform spraying pattern in spray systems having a relatively long length.

The application of freeze-point depressants on roadways has long been a method of combating the formation of ice. Traditionally, dedicated maintenance vehicles have applied solid or liquid chemicals to areas that have a high risk for developing ice. It is important to apply anti-icing chemicals to the roadway before freezing occurs, as this prevents a bond from forming between the ice and the roadway. The chemicals accomplish this by depressing the freezing point of the liquid on the roadway.

Often, highway sites such as bridges and overpasses will freeze before other portions of a roadway. The expense of sending a truck with anti-icing chemicals to such discrete sites, however, can be relatively high. Accordingly, many highway agencies have installed fixed anti-icing systems (FAS) at discrete locations, including for example bridges and overpasses. Fixed systems are also used at airports (e.g., runways and/or taxiways), parking lots, parking garages, sidewalks and other areas that experience only pedestrian traffic.

In some fixed systems, various sensors evaluate the current local conditions and automatically determine whether application of the anti-icing chemicals is merited. In various embodiments, the fixed systems are controlled locally at the site or are actuated from a remote location. One example of such a system is the FreezeFree™ automated anti-icing system available from Energy Absorption Systems, Inc., the assignee of the present application. In this and other systems, a reservoir and pump supply the anti-icing solution to a plurality of spray nozzles, which spray the solution onto the roadway.

Some fixed systems can be quite long, however, reaching lengths of over 3080 feet for example on various bridge installations. This can make the task of applying a measured amount of liquid through each nozzle more difficult, as many of the nozzles are positioned a great distance from the pump and reservoir. In particular, the outlying nozzles may experience a pressure drop due to the friction of the fluid in the supply line. In addition, the fluid in the supply line connecting the pump and nozzle has an inertia, which must be started in motion when an outlying valve/nozzle is opened. This effect can be magnified by changes in elevation between the pump and the nozzle.

As a result of these problems, an outlying valve/nozzle may spray 20% less fluid than a valve/nozzle located proximate the pump/reservoir. Part of the reason for the lower flow rate at the outlying valve/nozzle is that the system does not have time to come back up to pressure between successive valve openings. In particular, a valve/nozzle will spray for one time period and then be turned off for another time period before the next valve/nozzle sprays. During the delay, valves located distally from the pump/reservoir may not have enough time for repressurization. Although this problem can be somewhat mitigated by lengthening the time between sprays, the resulting extension of the overall spray time for the entire system may not be acceptable.

### SUMMARY

In one aspect, a method of applying an anti-icing solution to a roadway includes providing a plurality of spaced apart spray nozzles defining a system length. The plurality of spray nozzles are coupled to a plurality of spray valves. The method further includes supplying a pressurized anti-icing solution to each of the plurality of spray valves from a source of the anti-icing solution positioned upstream of the plurality of said spray valves. The method also includes opening the plurality of spray valves for a plurality of predetermined time periods, wherein the predetermined time periods of at least some of the plurality of spray valves are greater than the predetermined time periods of at least some other of the plurality of spray valves positioned upstream therefrom.

In one preferred embodiment, the predetermined time periods are determined or calculated at least in part as a function of the distance of each respective spray valve from the reservoir and/or pump supplying the anti-icing solution.

In another aspect, the method further includes spraying the anti-icing solution from each of the plurality of spray nozzles a predetermined distance. In one embodiment, the each of the plurality of spray nozzles has a spraying configuration, wherein the spraying configuration of at least some of the spray nozzles is different than the spraying configuration of at least some other spray nozzles. In one embodiment, the spraying configuration includes an orifice size. In other embodiments, the spraying configuration includes a discharge angle, or a combination of orifice size and discharge angle.

In one embodiment, the method includes successively opening the plurality of spray valves for the plurality of predetermined time periods. In addition, in one embodiment, the method further includes successively maintaining the plurality of spray valves in a closed position for a plurality of second predetermined time periods between the plurality of predetermined time periods the spray valves are opened. In one embodiment, the method includes automatically determining the predetermined time periods with a computer.

In another aspect, the method further includes monitoring the flow of the anti-icing solution through each of the plurality of spray valves. In various embodiments, the flow can be monitored using pressure switches, pressure sensors, flow sensors, temperature sensors and the like.

In one embodiment, the anti-icing assembly includes an anti-icing solution source, a valve in fluid communication with the anti-icing solution source, a nozzle connected to the valve, and a pressure detecting device coupled between the nozzle and the valve.

The various aspects and embodiments provide significant advantages over other anti-icing systems. For example, and without limitation, in one embodiment the system and method provide for each of the spray nozzles to spray substantially the same amount of anti-icing solution on the roadway or other surface being treated, regardless of the distance of the spray nozzle/valve from the reservoir or pump supplying the solution. As such, the system can be made longer without the need to provide multiple, and expensive, pumping stations, accumulators and the like. In addition, each of the spray nozzles in the system can be configured to spray the anti-icing solution a certain distance. The spray configuration, which can include without limitation an orifice size or discharge angle (positive or negative relative horizontal), can be easily adjusted to provide a uniform spray pattern over the entire system length.

The self-diagnostic monitoring system also provides advantages, especially for long-length systems. In particular, various fault conditions, including for example and without limitation a valve stuck closed, a valve stuck opened, and/or a clogged nozzle, can be easily detected without concern for the delay caused by pressure or flow changes occurring over a long-length system.

The foregoing paragraphs have been provided by way of general introduction and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a plan view of an anti-icing system installed on two parallel bridges.

FIG. 2A is a perspective view of a pump house.

FIG. 2B is a cross-sectional view of a pump house including a reservoir, pump assembly and controller taken along line 2B-2B of FIG. 2A.

FIG. 3 is an end view of a spray nozzle affixed to a roadside barrier.

FIG. 4 is a plan view of a pavement spray nozzle.

FIG. 5 is a cross-sectional view of a pavement spray nozzle installation.

FIG. 6 is a perspective view of one embodiment of a roadside spray nozzle.

FIG. 7 is a front view of a valve box with a cover removed.

### DETAILED DESCRIPTION OF THE PRESENTLY PREFERRED EMBODIMENTS

Referring to FIG. 1, a fixed anti-icing system 2 is shown as being installed on two parallel bridges 4, 6. Such fixed anti-icing systems can also be installed on ramps, overpasses, airports (taxiways and runways), roadways and various pedestrian and/or bicycle paths, including sidewalks, all of which are defined as “roadways.” The system 2 dispenses a liquid anti-icing agent by pumping one or more chemicals through a series of high-pressure spray nozzles 8 (shown as forty-four (44) nozzles), individually controlled by a series of motor-controlled ball valves, solenoid diaphragm valves 10, combinations thereof or other remote controlled valves. In one embodiment, a single nozzle (which may have multiple outlets or orifices) is associated with a corresponding valve, although it should be understood that in other embodiments a plurality (meaning two or more) nozzles can be associated with a single valve.

The term “anti-icing” as used herein means various solutions used to prevent and to eliminate icing on the roadway, and includes both anti-icing (pre-adhesion) and deicing (post-adhesion) agents/solutions. Suitable anti-icing agents include without limitation Sodium Chloride (NaCl), Magnesium Chloride (MgCl2), Calcium Chloride (CaCl2), Calcium Magnesium Acetate (CMA), and Potassium Acetate (KAc). Suitable anti-icing agents such as Potassium Acetate preferably have a “yellow-metal” (dezincification) inhibitor such as Cryotech GS4.

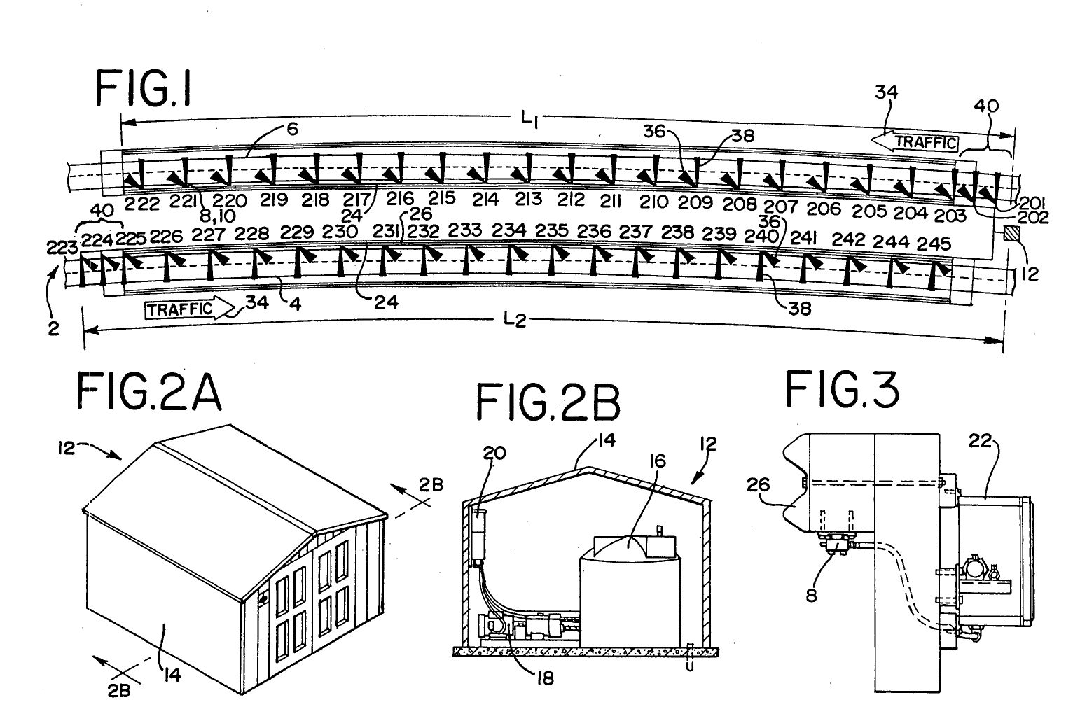

Referring to FIGS. 1, 2A and 2B, a pump house assembly 12 includes a weather proof pump house 14, a storage tank 16 or reservoir, a pump assembly 18 and a main controller 20 for the system. The anti-icing solution is stored or contained in the reservoir 16 for subsequent application to the roadway, e.g. the bridges 4, 6. The reservoir is preferably made of molded polyethylene. The capacity of the reservoir is dependent on the area to be treated and the estimated number of events per season.

In one preferred embodiment, the pump assembly 18 includes a electric motor driven, self-priming, positive displacement pump. The pump discharge pressure at 1200 rpm is preferably rated at 1000 psi [6895 kPa] at 16 gpm [60.5 L/min]. The pump is preferably directly coupled to a totally enclosed, fan cooled (TEFC), 1200 rpm, single-phase 3 hp [2.2 kW] motor. Electric pipe heating cable (120 VAC) is preferably included on the pump discharge, regulating valve and suction line.

Preferably, a telephone line (not shown) is located at the pump house for remote actuation, system monitoring, and data collection. A second telephone line is used for video transmission if a video monitoring system (not shown) is installed.

Referring to FIGS. 1, 2A, 2B and 7, the pump assembly 18, and in particular a pump discharge, is connected with piping or lines 24 to valve boxes 22 located at spaced apart distances along the bridge 4, 6. In this embodiment, the pump 18 is located upstream of the valves boxes 22 and nozzles 8. The valve boxes each include a valve controller 25 that receives commands from the main controller 20 in the pump house.

The valve controller is connected to and activates a valve 10, configured as a motor controlled or solenoid valve. When commanded by the main controller 20, the valve controller turns the valve 10 in the valve box on and off. The valve controller also performs system diagnostics and informs the main controller of various system anomalies. The valve 10 can take many forms, including without limitation a direct acting valve, a pilot operated valve, a rotary ball valve, or similar type valves. When the solenoid valve is activated, fluid is allowed to flow through the piping to the spray nozzles connected to the valve box 22 via conduit 23.

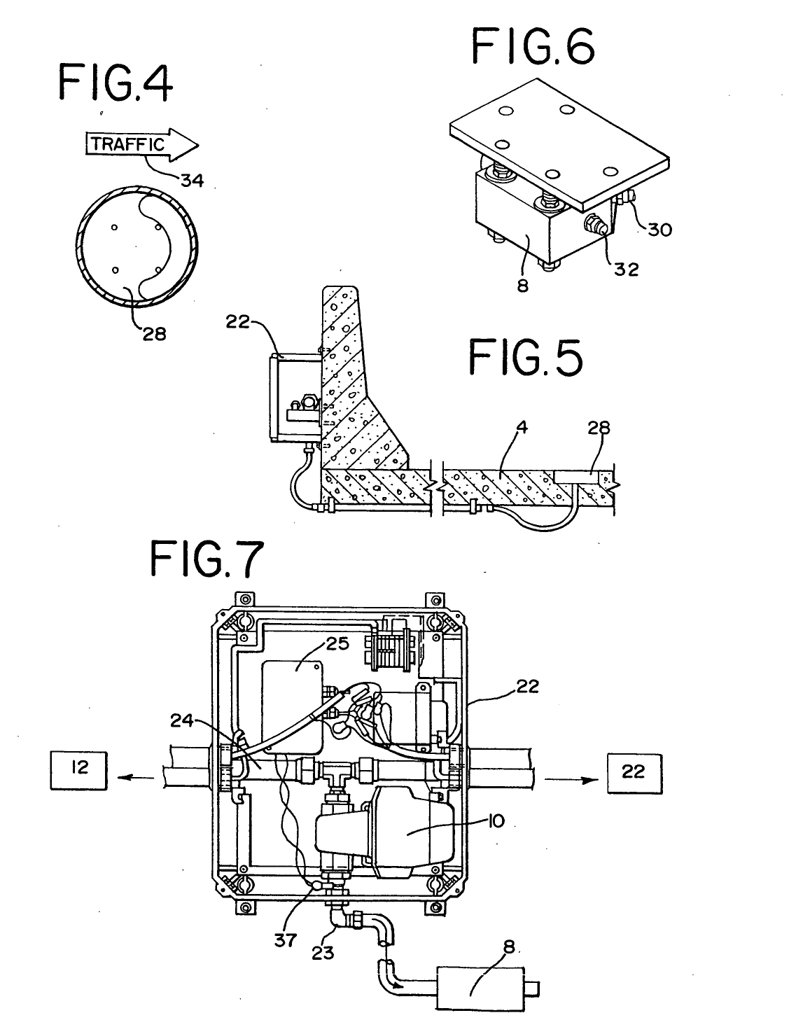

As shown in FIGS. 1, 3 and 6, the nozzles 8 are mounted on the side of the roadway 4, 6, for example on a roadside barrier 26 at an elevation spaced above the roadway, e.g., 12-15 inches, with a spray pattern that preferably does not exceed a predetermined height, e.g., 18 inches. In an alternative embodiment, shown in FIGS. 4 and 5, a nozzle 28 is flush mounted in the roadway 4. Alternatively, the nozzles can be flush mounted at the side of the roadway. Various nozzles and other components used in fixed anti-icing systems, are described in U.S. Pat. Nos. 5,447,272, 6,042,023, 6,082,638, 6,102,306 and 6,270,020, all of which are hereby incorporated by reference herein. Of course, it should be understood that other nozzle configurations would also be suitable, including nozzles having only a single outlet, and that the nozzles described herein are meant to be exemplary rather than limiting.

As shown in FIGS. 1 and 6, the nozzle 8 includes two (2) nozzle outlets 30, 32, although it should be understood that a single outlet, or more than two outlets would also work. One of the nozzle outlets 30 sprays the anti-icing solution in a spray pattern 36 at an angle (e.g. 45°) from and in the direction 34 of traffic. The other outlet 32 sprays the anti-icing solution in a spray pattern 38 across the roadway 4, 6 substantially perpendicular to the roadway 4, 6 and to the direction 34 of the flow of traffic. Preferably, nozzles 28 flush mounted in the center of a roadway, which preferably include a plurality of outlets, e.g., 7, spray in the direction of the traffic so as not minimize the interference with the traffic. Nozzles flush mounted at the side of the roadway are directed substantially perpendicular to the roadway and direction of traffic, with a portion of a fan shaped spray pattern (created by the plurality of outlets) directed against traffic, and with a portion directed with the traffic.

The system 2 applies a measured amount of anti-icing solution through the plurality of nozzles 8, 28 to the roadway surface. As shown for example in FIG. 1, the array of nozzles 8 includes a cluster 40 of three (3) nozzles more tightly spaced (e.g. 6 m) in the longitudinal direction at the initial spraying stage of the roadway and a greater longitudinal spacing (e.g. 12 m) of the remainder of the nozzles 8. In particular, the pump 18 is actuated to pressurize the lines 24, e.g., by providing a nominal pressure to the lines. In one embodiment, the pressure is about 200 psi, although systems can work with higher and lower nominal pressures. A bypass or pressure relief valve is provided in the system, so that once the nominal pressure is reached, the pump 18 continues to run, but with the flow from the pump bypassing the system back to the storage tank 16 or reservoir. The bypass operation helps to agitate and mix the anti-icing solution in the storage tank 16.

Once the nominal pressure is reached, the main controller 20, or remote processor unit (RPU), commands each of the spray valves 10 to open, preferably successively and sequentially, i.e., one at a time, to allow the system to spray. For example, and referring to FIG. 2, the nozzles are programmed to spray sequentially in order from 201 to 244. In particular, the nozzles spray sequentially on one side of the bridge starting with the nozzle 201 first encountered by the traffic flow and continuing along that side of the bridge until all of the nozzles on that side are sprayed, and then switching to the most distal nozzle 223 on the other side of the bridge, which is the nozzle first encountered by the traffic flow on that side, and continuing until the last nozzle 244 sprays.

Each spray valve 10 is left open for a predetermined time period, as calculated below. In one embodiment, at least one of the spray valves is left open for a predetermined time period of one second, with the spray nozzle 8, 28 spraying about 13 gallons per minute of flow. The spray outlets associated with each nozzle spray simultaneously. The RPU 20 preferably addresses the valves via an RS485 communication cable with repeaters, which are rated at −40° C. to 85° C. The system further includes a low deicing fluid level warning switch and a low deicing fluid level shut-off switch that prevent damage to the pump. An ultra sonic tank level sensor with capacity accuracy of <1.5% F.S. rated at −40° C. to 85° C. may also be used. An overall flow meter and/or pressure gauge/sensor can be located in the pump house, or other location, to determine whether a valve is stuck closed or open, although in long-length systems the lag time between the detected pressure change and the closing/opening sequence of a particular valve may make it difficult to pinpoint a problem. One suitable sensor is the Series 250 Metallic Tee Flow Sensor available from Data Industrial.

The complete spray cycle is repeated after all the valves 10 are fired in a first spray sequence, allowing each valve 10 and associated nozzles 8, 28 a second opportunity to spray for a second predetermined time period. The second round of spraying helps ensure that the section of roadway 4, 6 covered by each spray nozzle 8, 28 has chemical applied to it. This is particularly important where passing cars may disrupt the stream of one of the spray patterns 36, 38. The second spray sequence increases the likelihood that the anti-icing solution is distributed over the roadway. In one embodiment, where one of the nozzles sprays for a total of two seconds (two one second sprays) at 13 gallons per minute of flow, about 0.4 gallon of anti-icing solution is applied to the roadway by the respective nozzle.

In one embodiment, the actuation of the spray cycle provides a 120 VAC signal that activates an upstream warning light or message sign (not shown) to alert motorists of the anti-icing operation in progress. The anti-icing cycle can be initiated remotely via a remote dial-up communication, or by manually pushing a button at the controller assembly. Alternatively, the system can be automatically activated by an ice prediction system employed to accurately measure pavement surface and ambient atmospheric conditions. One suitable ice prediction system is used in the FreezeFree™ automated anti-icing system available from Energy Absorption Systems, Inc.

In one embodiment, the ice prediction system includes a pavement sensor that uses electrical conductivity measurements, surface temperature, and optical measurements to determine the state of the roadway surface. Suitable pavement sensors are described in U.S. Pat. No. 4,897,597 and U.S. Pat. No. 6,695,469, the entirety of which are hereby incorporated herein by reference. Depending on the particular system design, atmospheric sensors may also be employed. A computer algorithm analyses the measured data, water-layer thickness, depression of freezing point, and chemical concentration to provide ice and frost warning conditions and to automatically activate the spray system when icing conditions are predicted.

In a preferred embodiment, the piping system and lines 24 consists of ¾″ synthetic rubber hose connecting the pump discharge with the valves. Nylon 11 or 12 tubing preferably connects the valves with the nozzle assemblies. Preferably, all 120 VAC wiring is contained in conduit. All low voltage control wiring and fluid carrying hose are contained in schedule 40 galvanized pipe or PVC.

In one embodiment, the spray nozzle assemblies 8, 28 are constructed of a reinforced nylon block with brass fittings (outlets 30, 32) and stainless steel attachment hardware. Nozzle assembly designs are available for concrete barrier, and wood (see e.g., FIG. 3) or steel post guardrail installations. Flush-mounted pavement dispensers or nozzles 28 are also available as shown in FIGS. 4 and 5. In one preferred embodiment, the standard nozzle assembly is capable of spraying a distance of 29 ft [8.8 m] when installed 12-15 inches [305-381 mm] above grade. The specific nozzle design may be dependent on the width of the area to be treated. In one embodiment, the flush mounted pavement nozzle assembly is capable of spraying a pattern with a radius of 25 feet [7.6 m].

Preferably, each high-pressure spray nozzle 8, 28 is individually controlled by a corresponding valve, although it should be understood that more than one nozzle may be associated with one valve. The overall flow sensor (optional) and/or pressure sensor are used for system diagnostics during the spray sequence.

The pump house assembly 12 should be located as close as possible to the beginning of system, typically within 100 ft [30 m]. The storage tank 16, which is located within the pump house, is preferably accessible for filling by a tank truck, although a remote fill location can be provided. The storage tank 16 should be sized to provide sufficient deicing liquid for the entire winter season. The default sizing assumption is 50 anti-icing treatments.

As shown in FIG. 1, the system has an overall length (L) equal to the greatest length between the pump house and the most distant valve, e.g., L2. If the pump house were located and connected to the pipe system on only one side of the bridge, e.g., adjacent nozzle 222, the overall length L=L1+L2. In operation, the time period that each spray valve 10 is open is predetermined such that each nozzle 8 applies the same amount of liquid to the roadway, regardless of how far the nozzle 8 or spray valve 10 is located from the pump 18. In particular, the spray time for each nozzle 8 is determined as a function of one or more variables, including but not limited to (1) the distance of the spray nozzle from the pump house (increased spray time for a greater distance), (2) the relative elevation of the nozzle (i.e., the rise or fall of the supply line) relative to the pump house (increased spray time for elevation gain and decreased spray time for elevation loss.), (3) the system temperature, which can affect the viscosity of the anti-icing fluid (increased spray time for low temperatures), (4) the nominal duration of the spray (e.g., a two second spray will not spray twice as much fluid as a one second spray because a pressure drop, as the spray progresses, results in less fluid being sprayed at the end of the spray sequence than at the beginning), and (5) the configuration of the hose/nozzle connection to the valve (e.g., a long section of nylon tubing between the valve and nozzle (e.g. ⅜ inches) or a narrower diameter can decrease the flow through the nozzle).

In one embodiment, the system includes a settable pressure regulator (not shown). The pressure can be increased or decreased prior to a spray operation depending upon the proximity of the nozzle to the pump house. Likewise, the pressure can be increased for nozzles that are higher in elevation than the pump house, or decreased for nozzles lower in elevation.

Using various parameters, the nominal spray times for the nozzles are adjusted such that substantially the same volume of anti-icing solution is sprayed from each spray nozzle. In one embodiment, where the spray times are adjusted, any single nozzle sprays an amount or volume of liquid within 10% of the spray volume of any other nozzle. In another embodiment, where the spray times are adjusted, any single nozzle sprays an amount of liquid within 4% of the spray volume of any other nozzle. In yet another embodiment, where the spray times are adjusted, any single nozzle sprays an amount of liquid within 1% of the spray volume of any other nozzle. In contrast, without an adjustment to spray times, the last nozzle in a system will spray substantially less fluid, for example 21% less fluid.

In addition, the overall system sprays substantially the same volume as a calculated nominal value. In one embodiment, the overall system sprays less than about 4% of the nominal amount with an adjustment to the spray times, and in various embodiments less than or equal to about 2% or less than or equal to about 1% of the nominal amount with an adjustment to the spray times. In contrast, the overall system sprays for example about 12% less than the nominal amount without an adjustment to spray times.

In one preferred embodiment, the system includes a learning algorithm that used the following input parameters to determine the spray time for each nozzle: Flow rate, Pressure, Temperature, Nominal Spray Time, and Valve Number. As the system is used, the nominal spray time is adjusted for each valve until the correct value is obtained.

In one particular embodiment, the algorithm allows the user to calculate the predetermined time each nozzle 8, 28 sprays or each valve 10 is opened. This algorithm can be followed using manual measurements and adjustments, or it can be automated using a computer, such as the main controller 20. In any event, the user must first decide how much spray per valve is desired to be applied to the roadway or pavement. In one embodiment, the preferred spray is 28 gallons per lane mile, which generally corresponds to a predetermined spray time of 1 second for each of two sprays per nozzle. This is for an average valve spacing of 40 feet where each valve and associated nozzle covers 2 lanes.

To calculate the predetermined spray time for each valve/nozzle, a first estimated time of spraying is determined using the equation:
X=ZY(897.6)−0.306

In where, X=Estimated seconds of spray, Y=Average spacing between each nozzle in feet (=System length (L)/No. valves) (assuming system covers 2 lanes) and Z=Gallons/Lane mile. These equations assume one nozzle per valve and would need to revised accordingly as understood by those of skill in the art if more than one nozzle were attached to each valve.

Next, the equation G=ZY/5280 is used to determine the required gallons of spray per nozzle, where G=Gallons of spray per nozzle.

Next, the equation D=L/338+1 is used to determine the initial time delay for spraying each valve, where D=Delay time in seconds and L=Longest length of run from the pump to the farthest valve in feet (L2 as shown in FIG. 1). The time delay is the pause between the opening of adjacent valves/nozzles during system spraying. Although in this example, the time delay is a fixed amount for all valves, the time delay could vary between valves. In one alternate embodiment, the time delay can be a nominal amount for a series of valves, say ten valves and then longer for the eleventh valve. It should also be noted that the time delay for normal spraying is typically 2 seconds. For short systems, where L is less than 338′, the value of D is set to be equal to this 2 second value.

If the system has an individual valve that has some thing that will restrict its flow, such as a connector hose that is longer than 10 feet from the valve to the nozzle, or multiple paths that have a difference of 10 feet or more in altitude, then the user sets a number of zones equal to the number of valves in the system and the spray time for all zones (valves) is set to X seconds as calculated above. The use of zones provides a logical way of dividing the valves in the controller's firmware, so that specific operating parameters can be applied to groups of valves, rather than to individual valves. In this example, each zone has only one valve in it.

However, if the system is longer than 300 feet but does not have anything that will restrict the flow and does not have multiple paths having a change of altitude of 10 feet or more, then the user sets a maximum number of valves per zone to 8 The number of zones is then equal to the number of valves, divided by 8 and rounded up to the next nearest integer. In this example, six zones have 8 valves and 2 zones have 7 valves. The amount of valves for each zone is determined by the following equations:
Aₙ=F₂−F₁+1
F₁=Integer value of((V_{T}/Z_{T})*(Zₙ−1))+1
F₂=Integer value of(V_{T}/Z_{T})*Zₙ)

Where:
Aₙ=The amount of valves for zone n
F₁ is the number of the first valve in zone Zₙ
F₂ is the number of the last valve in zone Zₙ
V_{T} is the total amount of valves in the system
Z_{T} is the total amount of zones.
n is the number of the zone in question.
   Equations F₁ and F₂ spread out the amount of valves per zone as evenly as possible.
   It should be noted that using 8 valves per zone is used to simplify the calculations required. If all of the calculations are automatically performed by the main controller, one valve per zone can be used in all cases.

It should also be noted that in one embodiment of the system, setting the spray time in the firmware to a value of zero seconds turns off that particular valve and prevents it from spraying during a system spray. In this particular system, the minimum spray time is 0.2 seconds, and spray times can be incremented by a minimum of 0.001 seconds.

After the above calculations are completed, the following procedure is followed to correct the amount of fluid sprayed from each valve.
1. The initial spray time for each zone is set to the value X.
2. The time between sprays is set to D seconds.
3. The system is sprayed for one cycle, meaning each nozzle is sprayed once. As this is done, the RPU will collect and record the amount of fluid sprayed by each valve using the system's flow meter.
4. When the system has sprayed all valves, the Measured Gallons sprayed per zone is calculated. For systems with one valve per zone, this equals the amount of fluid flow that the RPU measured for each valve. For systems with multiple valves per zone, the total of all the valves in each zone needs to be summed.
5. The spray time is adjusted for any zone that did not spray the required amount. For one embodiment of the system, a spray time adjustment of 0.1 seconds equals about 0.017 gallons. Using this, the spray time Tₙ added to each zone can be calculated, Tₙ=(G−M/Aₙ)/0.17, where G=Required Gallons sprayed and M=Measured Gallons sprayed per zone. Note that the value of Tₙ will be different for each zone.
6. The above procedure is repeated, with additional system sprays and adjustments made as necessary.
7. The time that each zone is now set to spray is now retrieved from the RPU.
8. The total gallons sprayed by the system on its last spray is also retrieved from the RPU. This value is logged as S1.
9. The time between sprays is set to the required 2 seconds.
10. The system is sprayed again.
11. The total gallons of spray of the system after this last spray is logged as S2.
12. The time adjustment T2ₙ to add to each zone is calculated using the following equation: T2ₙ (time adjustment per zone)==(11.7647*(S1−S2)*(n−K))/(N−K)ˆ2 where N=The number of valves in the system, n=The number of the zone to add the time to, and K=The number of the zone that is 320 feet away from the pump.
13. T2ₙ seconds is added to the spray time for each zone. Note that the value of T2ₙ may be different for all of the zones.
14. Each spray nozzle is adjusted, so that they spray out the required distance, which is measured by the user.

The last adjustment is made by altering the spraying configuration of the spray nozzle 8, 28. For example if a flush mounted nozzle 28 is used, and if an individual nozzle is spraying too far, the user can drill out spray orifices in the nozzle. If the individual nozzle is spraying not far enough, the one or more spray orifices can be plugged. In either case, larger or smaller orifices can be drilled to fine tune the nozzle. It should be understood that the term “spraying configuration” means any aspect of the nozzle that affects the distance the nozzle sprays, including for example and without limitation the orifice size and discharge angle.

If a side mounted nozzle 8 is used, the spraying configuration of the nozzle can be changed by adjusting the size of the orifice and/or discharge angle that the nozzle sprays relative to a horizontal plane to increase or decrease the distance that the nozzle sprays. This is done by loosening a front screw and sliding the nozzle assembly 8 up or down in a slotted retaining clip. The discharge angle can be positive or negative relative to a horizontal plane, depending on the predetermined distance, the height of the nozzle, and the maximum desired height of the spray.

It should be understood that the calculated spray time is a function of several different factors. Accordingly, for a long length system, with all other parameters being the same, valves located downstream typically will be open for longer time periods. However, in other systems, including relatively short systems, other parameters may override the long-length problem. For example, if a system runs downhill, the valves located upstream may have to be opened for a longer time period. Alternatively, if one or more nozzles are located a relatively greater distance from their respective valve, the associated valve may have to be opened for a longer time period. In addition, the ambient temperature may have an effect, requiring increased or decreased spraying times at the respective valves.

For the anti-icing system 2 to work properly, all of the nozzles 8, 28 and valves 10 must work as intended. Because the system is typically located at a remote location, clogged nozzles and/or non-functioning valves may be difficult to detect. This places a premium on systems that have self-diagnostic systems and are able to determine when corrective action is necessary. Valves 10 and nozzles 8, 28 that are remote from the pump house 12 are particularly in need of self-diagnostics. Moreover, due to the large number of nozzles and valves in any one system, the self-diagnostics that are used need to be low cost.

For self-diagnostics in the valves and nozzles to be effective, the following fault conditions need to be detected: valve stuck closed, valve stuck open, and clogged nozzle. A pressure gauge or a flow meter located in the pump house 14 can detect the first two of these faults involving individual valves. This becomes difficult in large systems, however, as the pressure or flow change may lag the time the stuck valve(s) is opened and/or closed. In particular, the delay could be larger than the amount of time that is provided between the sprays of individual nozzles, making detection of an individual nozzle's faults difficult.

One solution to the need for self-diagnostics at each valve involves including a pressure detecting device, such as a pressure switch 37, at each valve 10, as shown in FIG. 12. The pressure switch is placed just downstream of the valve, between the valve 10 and the spray nozzle 8, 28. The pressure switch is used to provide for self-diagnostics. In particular, the pressure switch is first monitored immediately after the valve 10 is commanded to open. If the valve opens as intended, the pressure switch immediately closes, verifying that the valve is functioning normally. Second, the pressure switch is monitored after the valve is commanded to close. If the pressure switch does not open quickly, the valve may not have closed as commanded. Alternatively, the spray nozzle 8, 28 may be clogged, preventing the anti-icing fluid from being sprayed on the roadway. Failure of the pressure switch to close and/or open when expected can be further diagnosed by monitoring the system flow. This would allow the user/system to determine whether the valve is stuck open, or whether the nozzle is clogged. It should be understood that the pressure switch can be configured to open or close, i.e., change state, when subjected to either an increase or decrease in pressure.

The particular sequence for detecting a problem is as follows: (1) a spray command is issued, (2) a specified spray time passes, (3) the spray command is stopped, (4) the valve controller memory is checked to determine whether the pressure switch changed state (e.g., closed or opened) during the spray time, (5) an error is logged if the pressure switch did not change state, (6) a non-spraying time passes (e.g., 1.4 seconds), (7) the switch closure memory is cleared in the valve controller, (8) the valve controller memory is checked to determine whether the pressure switch stayed open (or closed) during the non-spraying time, and (9) an error is logged if the pressure switch change stated, e.g., closed.

In one embodiment, if the pressure applied while the valve is open (valve-open applied pressures) is less than a predetermined valve-open pressure, the controller will send an error signal, which can be stored or transmitted to an operator thereby allowing the operator to quickly evaluate the system, pinpoint the problem nozzle/valve and facilitate a fix thereto. If the pressure applied while the valve is closed (valve-closed pressure) continues to be applied after the valve is closed and/or is greater than a predetermined valve-closed pressure (e.g., 0), the controller can again send and/or store an error signal.

The self-diagnostics at each individual valve can also be accomplished using other pressure detecting devices, for example and without limitation, by using a pressure sensor instead of a pressure switch. The advantage of the pressure sensor is that the controller can be setup to evaluate the pressure values that determine whether an error has occurred. In particular, the pressure sensor is connected to the output of the valve while it is spraying, such that a pressure v. time curve can be generated. An analysis of the curve will let the RPU know if the valve is spraying and if the nozzle is clogged. For example, if the pressure is too low during a spray, it can mean that the valve is not completely open or that the hose between the valve and nozzle is broken. If there is no pressure during a spray sequence, it can mean that the valve did not open. If the pressure decreases too slowly after a spray is complete, it can mean the nozzle is clogged.

As an alternative to a pressure detecting device, a flow sensor can be used to monitor the flow at each valve. The flow sensor is placed in the same location as the pressure switch discussed above, just downstream of the valve, between the valve and the spray nozzle. If the valve is commanded to open, but there is no flow, the system would log an error that either the valve is not functioning, or the nozzle is clogged. A partially clogged nozzle is detected by measuring a reduced flow. A valve that is stuck open would be sensed, as the flow would continue after the valve is commanded to close.

The flow sensor could be replaced by simplified flow detecting means. For example and without limitation, a temperature sensor can be used. In particular, the temperature sensor is attached to the outside of one of the pipes, or inside of the pipes, downstream of the valve. The temperature is monitored, with the flow of the anti-icing fluid causing a corresponding drop in the temperature reading. This type of device would not measure actual flow amounts, but rather whether flow occurred.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A method of applying an anti-icing solution to a roadway comprising:
providing a plurality of spaced apart spray nozzles defining a system length, wherein said plurality of spray nozzles are coupled to a plurality of spray valves;
supplying a pressurized anti-icing solution to each of said plurality of spray valves from a source of said anti-icing solution positioned upstream of said plurality of said spray valves; and
opening said plurality of spray valves for a plurality of predetermined time periods, wherein said predetermined time periods of at least some of said plurality of spray valves are greater than said predetermined time periods of at least some other of said plurality of spray valves.

2. The method of claim 1 wherein said at least some other of said plurality of said spray valves are positioned at a greater elevation than said at least some of said plurality of said spray valves.

3. The method of claim 1 wherein a plurality of lengths of conduit connect said plurality of spray valves with respective ones of said plurality of said spray nozzles, wherein said conduits connecting said at least some other of said plurality of said spray valves to respective ones of said plurality of said spray nozzles valves have a lesser length than said conduits connecting said at least some of said plurality of said spray valves to respective ones of said plurality of said spray nozzles valves.

4. The method of claim 1 wherein said supplying said pressurized anti-icing solution comprises pumping said anti-icing solution from a reservoir positioned upstream of said plurality of said spray valves.

5. The method of claim 1 wherein said at least some other of said plurality of spray valves are positioned upstream of said at least some of said plurality of spray valves.

6. The method of claim 5 wherein said plurality of said spray valves are positioned a plurality of distances from said reservoir, and further comprising determining said plurality of predetermined time periods as a function of said plurality of distances.

7. The method of claim 1 wherein each of said plurality of spray nozzles is associated with a corresponding one of said plurality of spray valves.

8. The method of claim 1 further comprising spraying said anti-icing solution from each of said plurality of said spray nozzles a predetermined distance.

9. The method of claim 8 wherein each of said plurality of said spray nozzles has a spraying configuration, wherein said spraying configuration of at least some of said spray nozzles is different than said spraying configuration of at least some other of said spray nozzles.

10. The method of claim 9 wherein said spraying configuration comprises an orifice size.

11. The method of claim 10 wherein said at least some other of said spray nozzles are positioned upstream of said at least some of said spray nozzles, and wherein said orifice size of said at least some other of said spray nozzles are smaller than orifice size of said at least some of said spray nozzles.

12. The method of claim 9 wherein said spraying configuration comprises a discharge angle.

13. The method of claim 12 wherein said at least some other of said spray nozzles are positioned upstream of said at least some of said spray nozzles, and wherein said discharge angle of said at least some other of said spray nozzles is smaller than said discharge angle of said at least some of said spray nozzles

14. The method of claim 1 wherein said opening said plurality of spray valves for a plurality of predetermined time periods comprises successively opening said plurality of said spray valves.

15. The method of claim 14 wherein said plurality of predetermined time periods comprises a plurality of first predetermined time periods, and further comprising successively maintaining said plurality of spray valves in a closed position for a plurality of second predetermined time periods between said plurality of said first predetermined time periods.

16. The method of claim 1 further comprising automatically determining said predetermined time periods with a computer.

17. The method of claim 1 further comprising monitoring the flow of said anti-icing solution through each of said plurality of spray valves.

18. The method of claim 1 wherein at least some of said plurality of predetermined time periods are the same.

19. The method of claim 1 further comprising spraying substantially the same volume of said anti-icing solution from each of said plurality of spray nozzles when each of said plurality of spray nozzles is opened for one of said predetermined time periods.

20. A method of applying an anti-icing solution to a roadway comprising:
providing a plurality of spaced apart spray nozzles defining a system length, wherein said plurality of spray nozzles are coupled to a plurality of spray valves;
pumping an anti-icing solution from a reservoir with a pump located at one end of said system length upstream of said plurality of said spray nozzles and spray valves, wherein said plurality of said spray valves are positioned a plurality of distances from said reservoir;
supplying said anti-icing solution to each of said plurality of spray valves from said reservoir;
successively opening said plurality of spray valves for a plurality of first predetermined time periods, wherein said first predetermined time periods of at least some of said plurality of said spray valves are greater than said first predetermined time periods of at least some other of said plurality of said spray valves positioned upstream of said at least some of said plurality of said spray valves, and wherein said plurality of first predetermined time periods are determined as a function of said plurality of distances of said spray valves from said reservoir; and
successively maintaining said plurality of spray valves in a closed position for a plurality of second predetermined time periods between said plurality of said first predetermined time periods.

21. The method of claim 20 wherein each of said plurality of spray nozzles is associated with a corresponding one of said plurality of spray valves.

22. The method of claim 20 further comprising spraying said anti-icing solution from each of said plurality of said spray nozzles a predetermined distance.

23. The method of claim 22 wherein each of said plurality of said spray nozzles has a spraying configuration, wherein said spraying configuration of at least some of said spray nozzles is different than said spraying configuration of at least some other of said spray nozzles.

24. The method of claim 23 wherein said spraying configuration comprises an orifice size.

25. The method of claim 24 wherein said at least some other of said spray nozzles are positioned upstream of said at least some of said spray nozzles, and wherein said orifice size of said at least some other of said spray nozzles are smaller than orifice size of said at least some of said spray nozzles.

26. The method of claim 24 wherein said spraying configuration comprises a discharge angle.

27. The method of claim 26 wherein said at least some other of said spray nozzles are positioned upstream of said at least some of said spray nozzles, and wherein said discharge angle of said at least some other of said spray nozzles is smaller than said discharge angle of said at least some of said spray nozzles

28. The method of claim 20 further comprising automatically determining said predetermined time periods with a computer.

29. The method of claim 20 further comprising monitoring the flow of said anti-icing solution through each of said plurality of spray valves.

30. The method of claim 20 wherein at least some of said first plurality of time periods are the same.

31. The method of claim 30 wherein at least some of said second plurality of time periods are the same.

32. The method of claim 20 further comprising spraying substantially the same volume of said anti-icing solution from each of said plurality of spray nozzles when each of said plurality of spray nozzles is opened for one of said first predetermined time periods.

33. An anti-icing assembly comprising:
an anti-icing solution source;
a valve in fluid communication with said anti-icing solution source;
a nozzle connected to said valve; and
a pressure detecting device coupled between said nozzle and said valve.

34. The anti-icing assembly of claim 33 wherein said pressure detecting device comprises a pressure switch.

35. The anti-icing assembly of claim 33 wherein said pressure detecting device comprises a pressure sensor.

36. A method of applying an anti-icing solution to a roadway comprising:
providing an anti-icing solution source, a valve in fluid communication with said anti-icing solution source, a nozzle connected to said valve, and a pressure detecting device coupled between said nozzle and said valve;
opening said valve; and
determining whether a valve-open pressure is applied when said valve is open with said pressure detecting device.

37. The method of claim 36 wherein said pressure detecting device comprises a pressure switch, and wherein said determining whether said valve-open pressure is applied when said valve is open comprises determining whether said pressure switch has changed state.

38. The method of claim 36 further comprising sending an error signal if said applied valve-open pressure is less than a predetermined valve-open pressure.

39. The method of claim 36 further comprising closing said valve and determining whether a valve-closed pressure continues to be applied after said valve is closed with said pressure detecting device.

40. The method of claim 39 wherein said pressure detecting device comprises a pressure switch, and wherein said determining whether said valve-closed pressure continues to be applied after said valve is closed comprises determining whether said pressure switch has changed state.

41. The method of claim 39 further comprising sending an error signal if said applied valve-closed pressure is greater than a predetermined valve-closed pressure.

42. The method of claim 41 wherein said predetermined valve-closed pressure is about 0.

43. The method of claim 36 wherein said pressure detecting device comprises a pressure sensor.
